(19) United States
(12) Patent Application Publication
(10) Pub. No.: US 2016/0224192 A1
(43) Pub. Date: Aug. 4, 2016

(54) SYSTEMS AND METHODS FOR A MULTIPLATFORM VIDEO PLAYER

(71) Applicant: Net2.TV, LTD, San Mateo, CA (US)

(72) Inventor: Randall L. CARR, San Francisco, CA (US)

(21) Appl. No.: 15/010,922

(22) Filed: Jan. 29, 2016

Related U.S. Application Data
(60) Provisional application No. 62/109,479, filed on Jan. 29, 2015.

(51) Int. Cl. G06F 3/0481; H04L 29/08; H04L 29/06

(52) U.S. Cl. CPC G06F 3/0481; H04L 65/1033; H04L 67/02

(57) ABSTRACT

Described herein are techniques for playing video segments on a multiplatform video player (MVP) that presents a consistent playing back environment across different platforms. The MVP determine a platform in which the MVP is operating. The MVP loads a platform-specific configuration file based on the determined platform, where the platform-specific configuration file enables the MVP to communicate with the determined platform. The MVP receives a requested player function from a user and translate the requested player function to one or more commands understood by the determined platform based, at least in part, on the information contained within the platform-specific configuration file.

### RELATED APPLICATIONS

This application relates to and claims priority under 35 U.S.C. §119(e) to U.S. Provisional Patent Application No. 62/109,479, filed on Jan. 29, 2015, and titled “Multiplatform Video Playlist Software for HTML/Javascript Platforms,” which is hereby incorporated herein by reference in its entirety.

### BACKGROUND

1. Technical Field

The subject matter disclosed in this application generally relates to playing video content on a video player.

2. Description of the Related Art

Today, with the ubiquity of multimedia digital content such as video streams that are available from the Internet, consumers can watch video streams on client devices as well as on traditional television. Presently, however, most client devices that are capable of playing video tend to have their own specific hardware, differing internal software configurations and methodology, and often completely unique application program interfaces (APIs) for controlling video playback. Typically, application programmers must spend significant time and effort to learn each device's working methodology and the relationship between hardware and software in order to write an application to play video successfully on these platforms. Further, because the specifics of the hardware platform can be different among different platforms, it is difficult to provide a common user experience for video playback regardless of the hardware platform on which the media player is running.

Therefore, there is a need in the art to provide systems and methods for improving a user's viewing experience across multiple player platforms and simplifying the task of customizing programs for different platforms. Accordingly, it is desirable to provide methods and systems that overcome these and other deficiencies of the related art.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates a data structure that includes three different playlists based on different bandwidth indices, according to some embodiments of the disclosed subject matter.

FIG. 2 illustrates a process of initializing a multiplatform video player, according to some embodiments of the disclosed subject matter.

FIG. 3 illustrates a process of determining a platform in which a multiplatform video player is operating, according to some embodiments of the disclosed subject matter.

FIG. 4 illustrates a process of playing one or more video segments by a multiplatform video player, according to some embodiments of the disclosed subject matter.

FIG. 5 illustrates a block diagram of a networked computing environment for providing a multiplatform video player, according to some embodiments of the disclosed subject matter.

FIG. 6 illustrates a block diagram of an exemplary media playback device, according to some embodiments of the disclosed subject matter.

FIG. 7 illustrates a playlist with multiple video segments, according to some embodiments of the disclosed subject matter.

### DETAILED DESCRIPTION

In accordance with the disclosed subject matter, systems, methods, and computer readable media are provided for a multiplatform video player.

Before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be made to the accompanying drawings and descriptive matter in which there are illustrated preferred embodiments of the disclosed subject matter.

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well-known in the art, are not described in detail in order to avoid complication of the disclosed subject matter. In addition, it will be understood that the examples provided below are exemplary, and that it is contemplated that there are other systems and methods that are within the scope of the disclosed subject matter.

The invention is generally directed to a multiplatform video player (MVP or video player) that presents a consistent environment from which many different applications utilizing video playback can be written without specific regard to a computing platform's underlying hardware or software specifics. The MVP can determine the browser or platform on which it is running and can automatically configure itself to run by loading any platform-specific files. In some embodiments, the MVP can maintain a consistent Javascript-based, application programming interface (API) for playing video stored in playlists, including dynamically inserted video advertisements.

As discussed in the background section, presently, most computing devices that are capable of playing video tend to have their own specific hardware, differing internal software configurations and methodology, and often completely unique APIs for controlling video playback. Typically, application programmers must spend significant time and effort to learn each device's working methodology and the relationship between hardware and software in order to write an application to play video successfully on these platforms.

The MVP disclosed in this invention eases the burden on application programmers by acting as an intermediary agent to the internal video implementation within smart TVs, mobile devices, standalone computers, or any other device having a browser interface. The MVP provides a common API for video playback, and, in some embodiments, most of the internal implementation details of each device are abstracted to simpler programming operations, such as Play, Pause, and Seek. In some embodiments, the MVP can further include functionality to simplify seek operations in playlists that comprise collections of video content and advertising element metadata, which otherwise would be quite complex. As discussed in more detail below, the simplification provided by the MVP is even greater when the video playlist requires the use of dynamically inserted advertising videos.

In some embodiments, the MVP manages playback operations within internal modular software components, and automatically loads any advertisements, tracks video progress, and sends video-specific events back to the parent application. From the perspective of the user, the playback of a complex playlist using the MVP appears to be the same as if the video was one continuous stream of data.

Another advantage of the MVP is in the way it streamlines how an application programmer can specify and play back video(s), without having to have a detailed understanding of the particular features and quirks of each device.

In some embodiments, the MVP manages the actual loading of the video content via the playlist definitions. These playlists can contain any combination of content, dynamic advertisements, and associated advertising impressions for each advertisement. The MVP handles all the details as each video is played and additionally returns a complete status during playback. In some embodiments, the status can follow the standardized HTML5-compliant event/API model.

In some embodiments, the MVP can read a single link (such as a URL) for a video or a playlist, which can comprise a simple metadata format for video content, advertisements, and other metadata to control playback. The MVP is able to interpret a playlist into a continuous media container, which allows sparse access to different playback-points, potentially across different video segments without the parent application having to maintain state information. These random access points also may cause an advertising video to play if configured to force ad breaks. In this way, the MVP could prevent a user from skipping over advertisements that are a required part of the playback experience, if so desired.

One goal of the MVP is to provide a common user experience for video playback, regardless of the specifics of the hardware platform on which the media player is running. In the prior approaches, this would require having the application programmer learn each particular nuance or detail of the platform, just to get video to play. The MVP helps alleviate the barriers between platform and application by abstracting much of the platform's details, allowing the application programmer to concentrate on other parts of an application's development.

In some embodiments, the MVP eases the burden on the programmer by seamlessly making a playlist act like a single video stream and have platform independence via the player modules. The MVP additionally provides the ability to dynamically insert advertisements, as specified by the playlist, during video playback.

When the MVP is first initialized, the video player detects the resident platform and/or browser environment, and loads and configures one or more platform-specific files. In some embodiments, the one or more platform-specific files are stored locally and be retrieved therefrom. In other embodiments, the one or more platform-specific files are stored on a server, and the MVP can send a request to the server and retrieve the one or more files from the sever. In some embodiments, the platform-specific files have been specifically written to the platform's software development kit's specification. By using platform-specific files, even if the platform presents a unique technique from which the video is to be played, the MVP will target the required methods but still present the same API and return events as if the method were a standardized and/or common technique, conforming to the HTML5-Video standard model. Although HTML5-Video standard is discussed in the present application, other suitable standards are also within the scope the subject matter.

There are great differences in internal implementations by different manufacturers and providers. Although industry standards exist that attempt to promote standardized interfaces for video playback, most common platforms available today actually deviate from these standards, do not use them at all, or typically contain vastly different behaviors that can make it extremely challenging for an application programmer to get consistent playback across these devices. The MVP facilitates greatly in resolving much of the complications that can arise, leading to an acceleration of the development process.

The MVP is able to convert methodologies specific to each embedded hardware platform, and uniformly return behavior and events as if the platform contained, for example, a standard HTML5-compliant video player. Additionally, even on platforms that actually contain an HTML-5 standardized compliant player, there are still distinct behaviors or non-compliance due to differences in hardware and operating system oddities. The MVP coalesces these disparities into a uniform result, again freeing the application programmer from having to deal with the inconsistencies when playing video.

Additionally, as newer or previously unsupported platforms become available, the MVP can be easily extended to utilize a new video playback “adapter” for handling any quirks in platform video playback. The adapter would then be automatically loaded once run upon the newer platform.

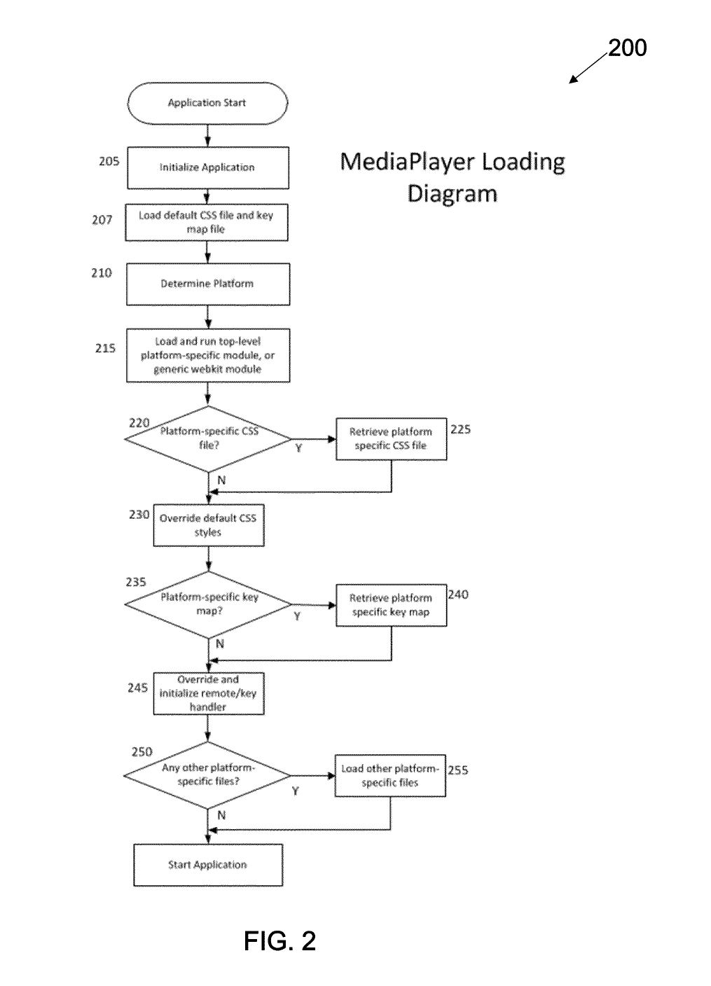

FIG. 2 illustrates a computerized process 200 of initializing a multiplatform video player, according to some embodiments of the disclosed subject matter. The computerized process 200 can be modified by, for example, having steps rearranged, changed, added, and/or removed.

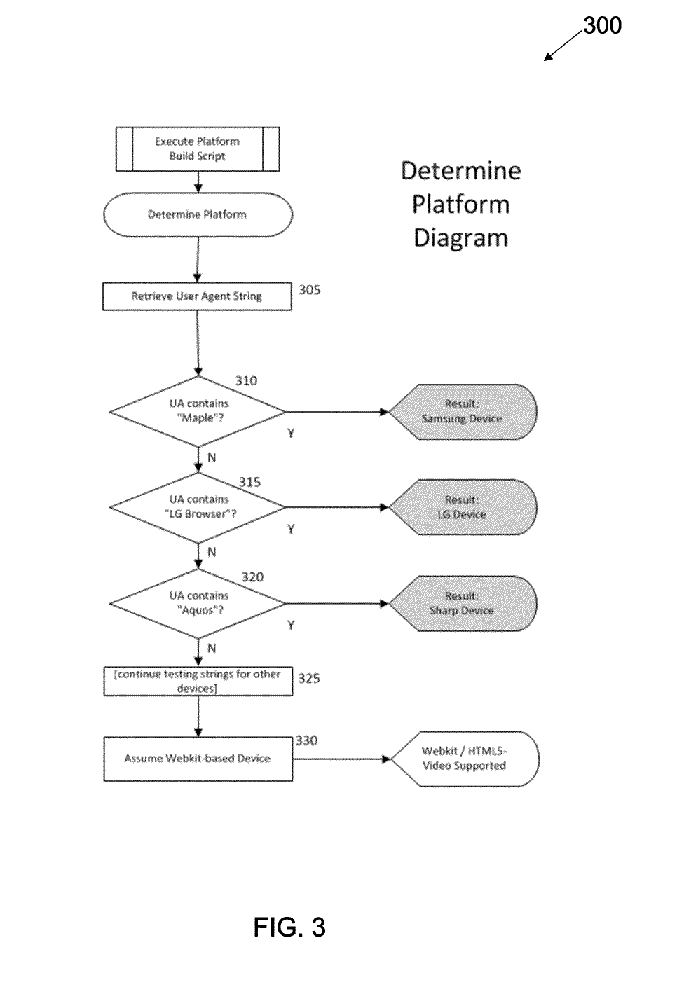

When the MVP is first loaded, its first task is to initialize itself (step 205). For example, in some embodiments, the MVP can load a default Cascading Style Sheets (CSS) file and key map file (step 207). The software then determines the platform on which it is running (step 210). The process of determining the platform itself requires several steps, which are described in more detail below in connection with FIG. 3.

Once the MVP has determined the platform on which it is running in step 210, it can automatically configure itself for the determined platform, which may involve retrieving and loading additional files. These modules may then execute other functions, some proprietary to each platform, to do some secondary checking to get more information about the platform, such as whether certain capabilities are available, such as Apple's “HTTP Live Streaming” (HLS) or support for differing input devices. Additional information about HLS manifest files can be found in R. P. Pantos, “HTTP Live Streaming: draft-pantos-http-live-streaming-13,” IETF, Apr. 16, 2014, which is incorporated herein in its entirety by reference. The overall goal is to provide the user with a consistent user interface, regardless of the platform on which the MVP is running.

In step 215 of FIG. 2, based on the outcome of step 210 (“Determine Platform”), the MVP determines whether it is running on a Webkit platform. Details regarding Webkit can be found at http://www.webkit.org, which is incorporated herein by reference. If so, the MVP loads a generic platform webkit file. If the MVP determines that it is not running on a Webkit platform, it maps the determined platform to the correct platform-specific file, and then loads and runs the Javascript file for whatever platform was determined in step 210. The high level Javascript file may be different for each platform—some platforms may require additional CSS files, key map files, and other special files to support the player functionality, whereas other platforms may inherently support much of the functionality and need only a CSS file. In some embodiments, the MVP would emulate as much as possible the HTML-5 standard for video playback, including all the events that are documented in the W3C standard, and would convert all the remote control keypresses to the uniform set defined in the Consumer Electronics Association standard CEA-931-A. Details regarding the W3C standard can be found at https://www.w3.org/TR/htm15/, which is incorporated herein by reference. Details regarding the CEA standard can be found at http://www.cta.tech/Standards/Standard-Listings.aspx, which is incorporated herein by reference.

Certain platforms, for example, do not support an HTML5-style video player. Instead, each device has a specialized module API and implementation embedded in the device's internal firmware that controls video playback and other functions. And, the available video playback doesn't have a one-to-one correspondence to what is needed by the MVP's HTML5 implementation. The platform-specific file loaded by the MVP understands how to translate a requested player function into the API calls understood by the platform. And, events detected by the platform are likewise translated into events that are understood by the MVP. From the perspective of the MVP, the event would look as if it had come from a standardized HTML-5 player.

In some cases, the implementation of a platform might have missing functionality, equivalent functionality, or bugs that may interfere with making the platform module compatible. Because of this, in some embodiments, the platform module may load specialized code to duplicate what is missing from the device's implementation. For example, when a video ends, the standard HTML-5 compliant implementation would trigger (send) an “ended” event to the code listening for HTML-5 events. But some platforms that are not compliant with HTML-5 do not trigger such an “ended” event. For those platforms, the platform-specific code may perform some internal computations to determine when a video actually ends and then sends an “ended” event to the MVP. Alternatively, the MVP might receive a non-standardized event from the platform to indicate the end of playback. In that case, the platform-specific file would receive the non-standardized event and know to send the “ended” event to the MVP. In another example, some non-compliant platforms do not send a “heartbeat” “timeupdate” event that tells the MVP to update the progress bar or to update the time passed. The platform-specific file must create this mechanism at the appropriate time and send the proper events at the proper time to the MVP.

Once the MVP has loaded the platform-specific file, that file performs its own series of steps, which may include tests of various platform parameters, to determine what additional files need to be loaded. In step 220, the platform-specific file determines if a platform-specific CSS file is needed and, if so, it loads the file in step 225. If a platform-specific CSS file is not needed, the process 200 proceeds to step 230.

In step 230, the CSS styles are overridden, either by the platform-specific CSS file or by the standard MVP CSS styles. Next, in step 235 the MVP platform-specific file determines if a platform-specific key map file is needed. If so, the MVP platform-specific file loads the platform-specific key map file in step 240. If a platform-specific key map file is not needed, the process 200 proceeds to step 245.

In step 245, the key map is either initialized with the loaded platform-specific file or by the standard MVP key map file. In step 250, the platform-specific file determines if any other platform-specific files are needed, in order to support the generic set of MVP functionality. The platform module code could query for an available plug-in module, a natively-implemented function integral to the browser itself, or any other items that can be queried. For example, the Javascript object that contains the “User Agent” string also contains many other named properties that give more information about the platform. In addition, many platforms include other globally defined objects, such as a “window” object, to which some vendors attach properties indicating what the platform can support.

For example, an available plug-in's existence can be determined by simply comparing its name to what is known as “undefined” in the Javascript programing language. If this name is defined, then the MVP knows that it can operate on methods or query properties that the plug-in might have. Once the plug-in is available, the MVP can either discover attributes or rely on a vendor's documentation to find out how their implementation of the plug-in affects the platform and, in most cases, how video may be played and controlled.

Based on what the MVP discovers about the platform, any necessary additional files are loaded in step 255. It should be understood that the order of these steps is unimportant. What matters is that the platform-specific file performs any tests that may need to be performed in order to determine what additional files may need to be loaded, and then loads any such additional files.

FIG. 3 illustrates a computerized process 300 of determining a platform in which a multiplatform video player is operating, according to some embodiments of the disclosed subject matter. The computerized process 300 can be modified by, for example, having steps rearranged, changed, added, and/or removed.

The MVP has varying ways of determining the identity of a particular platform, where the platform can be a device, a browser, or other suitable platforms. For example, one mechanism is to use what is known as a “User Agent” string discoverable on each platform's internal web Browser. Each browser and/or device manufacturer defines a unique “User Agent” string, which can be retrieved by the MVP and tested against known values. Currently, the format of the User-Agent string is specified by Section 5.5.3 of HTTP/1.1 Semantics and Content, which is incorporated herein by reference. The HTTP format of the User Agent string is essentially a list of product tokens (keywords) with optional comments.

In step 305, the MVP retrieves the User Agent string from the platform. In some embodiments, once the MVP has retrieved the User Agent string, the MVP performs a sequence of string search operations on it to determine if the string contains particular substrings that indicate the nature of the browser or device. For example, in step 310, the MVP searches for the sub-string “Maple” in the User Agent string. If the sub-string “Maple” is found, the MVP knows that the platform is a Samsung device. If the sub-string “Maple” is not found, then the MVP looks for a string indicating a different device. In step 315, for example, the MVP looks for the sub-string “LG Browser,” which, if found, indicates that the platform is an LG device. If the sub-string “LG Browser” is not found, the MVP, in step 320, looks for the sub-string “Aquos,” which, if found, indicates that the platform is a Sharp device. The MVP proceeds in this way, seeking known sub-strings within the User Agent string (step 325), until it runs out of known sub-strings. The particular sub-strings searched by the MVP are not important, as long as they uniquely correspond to particular manufacturers. Further, the order in which the MVP searches for sub-strings is not important. If the MVP exhausts its set of sub-strings without finding any matches, then, at step 330, the MVP assumes that the platform uses a browser based on Webkit/HTML5, which is an open-source web browser engine defined by the Webkit Open Source Project.

Once the MVP has been dynamically loaded and configured, as described above, it is ready to begin playing playlists.

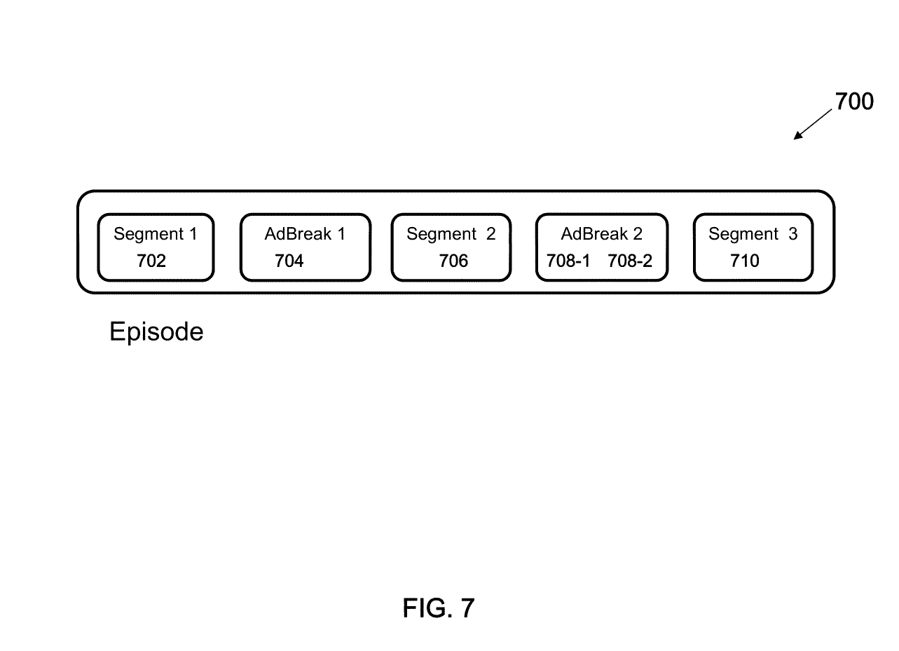

A playlist is composed of multiple video streams (segments) and dynamically inserted advertisements, assembled together into a linear stream. In some embodiments, the multiple video streams can be stitched into a playlist by a stitching server. Each individual segment represents a single piece of transcoded content hosted on a content delivery network. FIG. 7 shows a representation of a playlist 700. In the example below, the playlist is composed of three video segments alternating with two advertisement breaks (Ad Break), but any combination of segments and advertisement breaks are possible, in any order. Further, each advertisement break can have one or more advertisements. For example, in FIG. 7, Ad Break 2 can have two advertisements, 708-1 and 708-2. In FIG. 7, the combined five videos segments and Ad Breaks make one episode, or show.

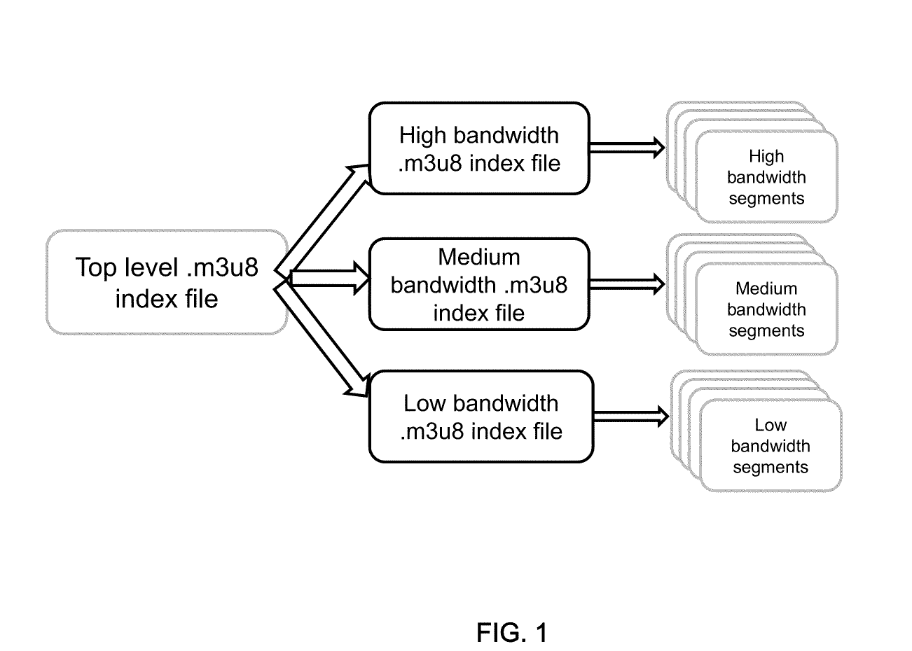

Each of the five videos is by itself a single video stream, which can be formatted as an HLS stream, mp4 stream, .mov stream, or any other commonly accepted video streaming format. If formatted as an HLS stream, the video comprises a top level .m3u8 manifest file, as defined in Apple's “HTTP Live Streaming” (HLS) adaptive streaming protocol. The top level .m3u8 manifest file points to the second level .m3u8 files for each transcode, as shown in FIG. 1, which depicts the overall structure of a typical set of HLS manifest files and segments. FIG. 1 shows an exemplary data structure that includes three different playlists based on different bandwidth indices. Although FIG. 1 lists three bandwidth indices (i.e., high bandwidth, medium bandwidth, and low bandwidth), more or less bandwidth indices can be used as well. As a non-limiting example, the high bandwidth, medium bandwidth, and low bandwidth can be 2.5 Mbps, 1.8 Mbps and 1.2 Mbps, respectively.

When the MVP first loads a playlist, it determines durations of each video content segment and summarizes them internally as one video-streaming component. The application programmer can then treat this video operation as one video without direct concern for its contents.

In some embodiments, as each video playlist's segments are played with the common HTML5-compliant API that is also provided by the MVP, operations such as play, pause, stop, and seeking are provided by having the MVP determine where in the playlist a playing marker is and appropriately loading the stream as needed.

If a segment is an advertisement, also known as an ad or Ad Break, normally the advertisement's information must be loaded-on-demand so as to not confuse an ad-server's tracking software that detects if advertisements are watched or not. Once the ad data is loaded, the metadata for the ad incorporates what are known as impressions or beacons. These are signals that are sent back periodically to the advertising ad server, which indicates which advertisements are actually watched by the user as the play progress within the ad (e.g., 25%, 50%, 75%), and whether the ad played back completely. This enables advertising credit to be given for each ad watched by a user. The MVP tracks each impression or beacon and sends the signals at the proper playback time, according to what ad videos were played and how impressions were defined for the playback session.

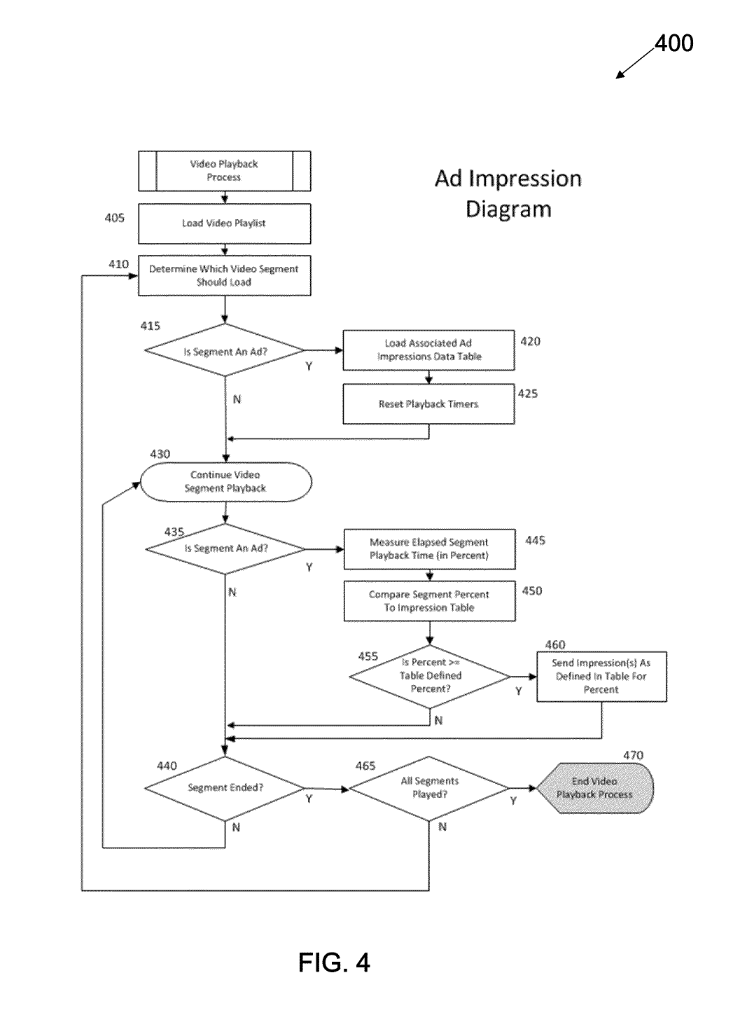

FIG. 4 illustrates a computerized process 400 of playing one or more video segments by a multiplatform video player, according to some embodiments of the disclosed subject matter. The computerized process 400 can be modified by, for example, having steps rearranged, changed, added, and/or removed. The first step is to load the video playlist (step 405). Once the video playlist has been loaded, the MVP, in step 410, determines which video segment in the playlist should load. It then determines if the segment is an advertisement (step 415). If the segment is not an advertisement, the process 400 proceeds to step 430. If the segment is an advertisement, the process 400 proceeds to step 420, where the MVP retrieves associated data relating to the timing and URLs for reporting of ad impressions from a network address associated with the advertisement segment. After that, the MVP resets its playback timers (step 425), so that it can accurately track how much of an ad has been played. The process 400 then proceeds to step 430.

In step 430, the MVP plays the video associated with the video segment or the advertisement segment. In step 435, the MVP determines if the segment that is going to be played a video segment or an advertisement segment. If the segment is not an advertisement (step 435), the MVP proceeds to step 440, where it checks to see if the entire segment has been played: if not, the MVP loops back to step 430, where it continues paying back the video segment. In one embodiment, when playing either a video or an advertisement segment, the MVP can support “trick play” features, which allow the user to change either the speed of playback or the current playback position within the video. For example, common trick play features include the ability to pause, skip back, or ahead by a fixed amount (e.g., 10 seconds), seek from frame to frame, jump to the end of a video, etc. In some embodiments, the MVP can be configured so that, if a user requests a particular trick play feature that would result in moving the playback position past an ad segment, the MVP will enforce the playback of the ad segment. In other embodiments, the MVP can be configured to allow certain trick play features when playing a video segment, but not when playing an ad segment.

If the MVP, in step 435, determines that the segment is an advertisement, then it proceeds to step 445, where it measures how much of the advertisement has been played, and compares the percentage of playback to the one or more thresholds stored in the impressions table associated with the advertisement (step 450). If a threshold has been met (step 455), the MVP sends an indication for an advertisement impression (an indication that a viewer has played that percentage of the ad) to the network address specified in the impression table (step 460). The MVP then returns to step 440.

If, in step 440, the MVP determines that the entire segment has been played, then it checks to see if there are any remaining segments in the playlist (step 465). If so, the MVP returns to step 410, where it determines the next segment to load. If all segments have been played, then the MVP ends the playback process (step 470).

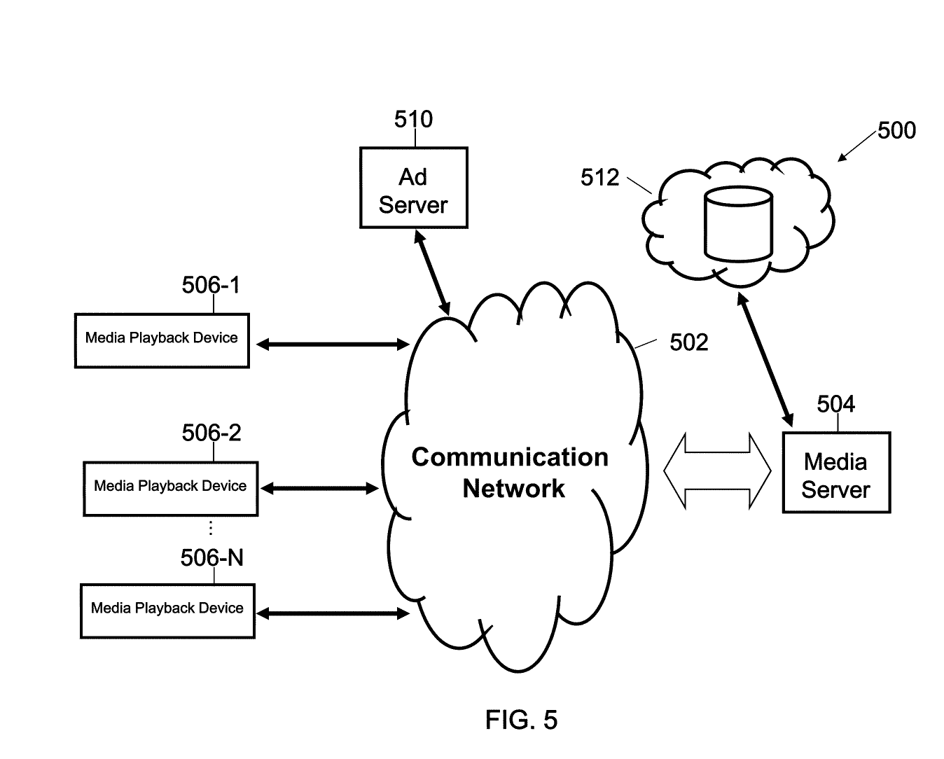

The disclosed embodiments can be implemented in a networked computing environment. FIG. 5 illustrates a block diagram of a networked computing environment for providing a multiplatform video player, according to some embodiments of the disclosed subject matter. The networked computing environment 500 can include a media server 504 coupled to a physical storage medium 512, at least one media playback device 506 (e.g., media playback device 506-1, 506-2, . . . , 506-N), and at least one ad server device 510, which can all be coupled directly or indirectly to a communication network 502.

Each media playback device 506 can communicate with the servers 504 and 510 across the communication network 502. Additionally, each media playback device 506 can be directly connected to servers 504 and 510 or can be connected via any other suitable device, communication network, or combination thereof. For example, each media playback device 506 can be coupled to servers 504 and 510 via one or more routers, switches, access points, and/or a communication network (as described below in connection with communication network 502). A media playback device 506 can include, for example, a desktop computer, a mobile computer, a tablet computer, a cellular device, a smartphone, a television, or any computing systems that are capable of performing computation. The media playback device 506 can include a module that is configured to enable a user to request a particular episode of a media item. In some embodiments, the media playback device 506 can be an HLS complaint HLS player. In some embodiments, the media playback device 506 can be a Portico media player provided by Net2TV.

The communication network 502 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. While FIG. 5 shows the network 502 as a single network, the network 502 can also include multiple interconnected networks listed above.

In some embodiments, the media server 504 stitches primary video content, such as streamed video segments, and secondary video content, such as advertisement segments, into a playlist and provides the playlist to the media playback device 506. The media server 504 is also referred to as a stitching server. Some embodiments of the media server 504 are disclosed in U.S. patent application Ser. No. 14/852,061, filed on Sep. 11, 2015, and titled “Server-side Playlist Stitching,” which is hereby incorporated herein by reference in its entirety. The media server 504 can be coupled to one or more physical storage media and/or one or more cloud storage media, which can be configured to store data for the media server 504. FIG. 5 shows the media server 504 and the physical storage medium 512 as separate components; however, the media server 504 and physical storage medium 512 can be combined together. The physical storage medium 504 can be located in the same physical location as the media server 504, at a remote location, or any other suitable location or combination of locations.

In some embodiments, the ad-server 510 can request and/or provide advertisement content for the advertisement breaks in the playlist. In some embodiments, the ad-server 510 can track each time the one or more advertisements are played, in whole or in part, by the media playback device 506. Some embodiments of requesting, providing, and/or tracking advertisement content are disclosed in U.S. patent application Ser. No. 14/924,402, filed on Oct. 27, 2015, and titled “Systems and Methods for Providing an Advertisement Calling Proxy Server,” which is hereby incorporated herein by reference in its entirety.

The media server 504 and/or the ad server 510 can operate using operating system (OS) software. In some embodiments, the OS software is based on a Linux software kernel and runs specific applications in the media server 504 and/or the ad server 510, such as monitoring tasks and providing protocol stacks. The OS software allows resources to be allocated separately for control and data paths. For example, certain packet accelerator cards and packet services cards are dedicated to performing routing or security control functions, while other packet accelerator cards/packet services cards are dedicated to processing network traffic. As network requirements change, hardware resources can be dynamically deployed to meet the requirements in some embodiments.

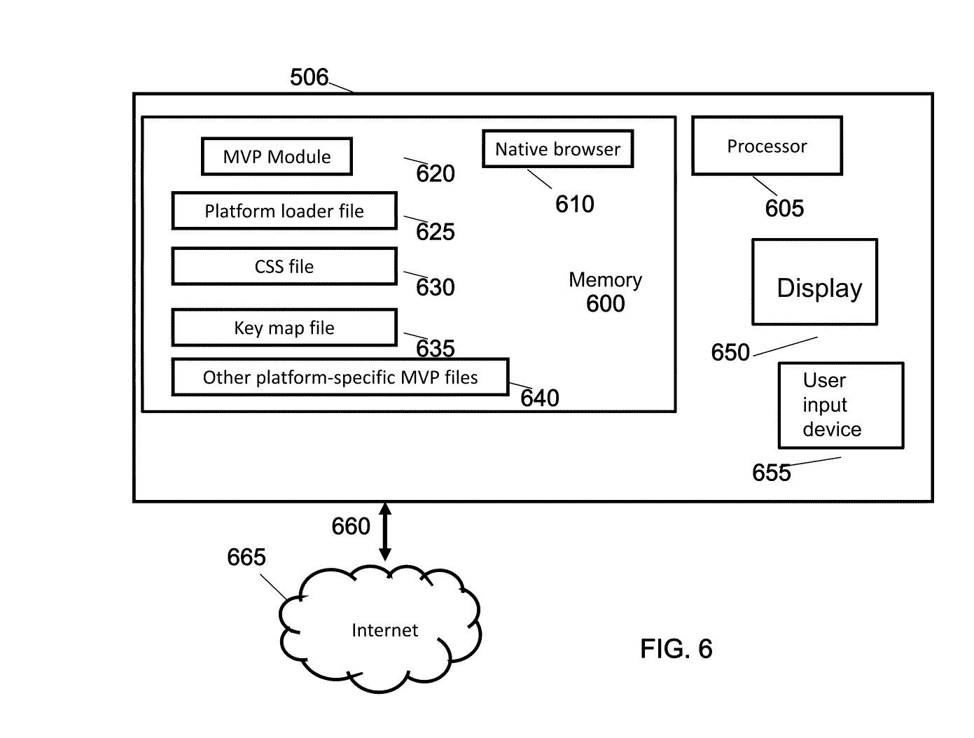

FIG. 6 illustrates a block diagram of a media playback device 506, according to some embodiments of the disclosed subject matter. The media playback device 506 includes a processor 605, a memory 600, a display 650, a user input device 655, and a network interface 660. The media playback device 506 can communicate with network servers (not shown) via the interface 660. The media playback device 506 may include additional modules, fewer modules, or any other suitable combination of modules that perform any suitable operation or combination of operations. In some embodiments, the media playback device 506 may include more than one processor 605. The display 650 and user input device 655 may be physically incorporated into the media playback device 506, or may be separate components.

In some embodiments, the processor 605 can include one or more cores and can accommodate one or more threads to run various applications and modules. The software can run on a processor 605 capable of executing computer instructions or computer code. The processor 605 might also be implemented in hardware using an application specific integrated circuit (ASIC), programmable logic array (PLA), field programmable gate array (FPGA), or any other integrated circuit. The processor also communicates with the memory and interfaces to communicate with other devices. The processor can be any applicable processor such as a system-on-a-chip that combines a CPU, an application processor, and flash memory.

The memory 600 can be a non-transitory computer readable medium, flash memory, a magnetic disk drive, an optical drive, a programmable read-only memory (PROM), a read-only memory (ROM), or any other memory or combination of memories.

The memory 600 stores browser code that is executed by the processor 605 to allow browsing the Internet. The memory 600 also stores the multiplatform video player (MVP) module 620, along with various associated files, including a platform-specific loader file 625, a cascaded stylesheet file 630, a key map file 635, and any other platform-specific files 640 that may be required by the MVP code 620 to be able to play media files on that platform.

In some embodiments, the MVP module 620 can be configured to cause the one or more processors to determine a platform in which the MVP module 620 is operating. The MVP module 620 can be further configured to cause one or more processors to load a platform-specific configuration file based on the determined platform, where the platform-specific configuration file enables the MVP module 620 to communicate with the determined platform. The MVP module 620 can be further configured to cause the one or more processors to receive a requested player function from a user. The MVP module 620 can be further configured to cause the one or more processors to translate the requested player function to one or more commands understood by the determined platform based, at least in part, on the information contained within the platform-specific configuration file.

Although the MVP is described in connection with systems that support a web-browser or internal Javascript engine, the techniques utilized and the methodologies described could easily be ported to different languages.

Although the disclosed subject matter has been described and illustrated in the foregoing exemplary embodiments, it is understood that the present disclosure has been made only by way of example, and that numerous changes in the details of implementation may be made without departing from the spirit and scope, which is limited only by the claims which follow.

A “server,” “client,” “agent,” “module,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or D.

What is claimed is:

1. A computerized method, comprising:
determining, by a video player, a platform in which the video player is operating;
loading, by the video player, a platform-specific configuration file based on the determined platform, wherein the platform-specific configuration file enables the video player to communicate with the determined platform;
receiving, by the video player, a requested player function from a user; and
translating, by the video player, the requested player function to one or more commands understood by the determined platform based, at least in part, on the information contained within the platform-specific configuration file.

2. The method of claim 1, further comprising receiving, by the video player, an event from the determined platform and translating the event into a format understood by the video player based, at least in part, on the information contained within the platform-specific configuration file.

3. The method of claim 1, wherein loading the platform-specific configuration file comprising:
sending, by the video player to a server, a request to receive the platform-specific configuration file; and
receiving, by the video player, the platform-specific configuration file from the server.

4. The method of claim 1, wherein the platform is a browser.

5. The method of claim 1, wherein the platform is a device.

6. The method of claim 1, wherein determining the platform comprises retrieving a user agent string from the platform and determining a value of the user agent string.

7. The method of claim 1, wherein the platform-specific configuration file is further configured to load one or more additional files compatible with the determined platform.

8. The method of claim 7, wherein the one or more additional files include at least a cascading style sheets (CSS) file or a key map file.

9. A non-transitory computer readable medium comprising executable instructions operable to cause an apparatus to:
determine a platform in which the a video player is operating;
load a platform-specific configuration file based on the determined platform, wherein the platform-specific configuration file enables the video player to communicate with the determined platform;
receive a requested player function from a user; and
translate the requested player function to one or more commands understood by the determined platform based, at least in part, on the information contained within the platform-specific configuration file.

10. The non-transitory computer readable medium of claim 9, wherein the executable instructions are further operable to cause the apparatus to receive an event from the determined platform and translating the event into a format understood by the video player based, at least in part, on the information contained within the platform-specific configuration file.

11. The non-transitory computer readable medium of claim 9, wherein the executable instructions are further operable to cause the apparatus to:
send, to a server, a request to receive the platform-specific configuration file; and
receive the platform-specific configuration file from the server.

12. The non-transitory computer readable medium of claim 9, wherein the platform is a browser.

13. The non-transitory computer readable medium of claim 9, wherein the platform is a device.

14. The non-transitory computer readable medium of claim 9, wherein the executable instructions are further operable to cause the apparatus to:
retrieve a user agent string from the platform; and
determine a value of the user agent string.

15. The non-transitory computer readable medium of claim 9, wherein the platform-specific configuration file is further configured to load one or more additional files compatible with the determined platform.

16. The non-transitory computer readable medium of claim 15, wherein the one or more additional files include at least a cascading style sheets (CSS) file or a key map file.

17. An apparatus, comprising:
one or more processors; and
a memory storing a program that, when executed, causes the one or more processors to:
determine a platform in which a video player is operating,
load a platform-specific configuration file based on the determined platform, wherein the platform-specific configuration file enables the video player to communicate with the determined platform,
receive a requested player function from a user, and
translate the requested player function to one or more commands understood by the determined platform based, at least in part, on the information contained within the platform-specific configuration file.

18. The apparatus of claim 17, wherein the program, when executed, further cause the one or more processors to receive an event from the determined platform and translating the event into a format understood by the video player based, at least in part, on the information contained within the platform-specific configuration file.

19. The apparatus of claim 17, wherein the program, when executed, further cause the one or more processors to:
send, to a server, a request to receive the platform-specific configuration file; and
receive the platform-specific configuration file from the server.

20. The apparatus of claim 17, wherein the platform is a browser.

21. The apparatus of claim 17, wherein the platform is a device.

22. The apparatus of claim 17, wherein the program, when executed, further cause the one or more processors to:
retrieve a user agent string from the platform; and
determine a value of the user agent string.

23. The apparatus of claim 17, wherein the platform-specific configuration file is further configured to load one or more additional files compatible with the determined platform.

24. The apparatus of claim 23, wherein the one or more additional files include at least a cascading style sheets (CSS) file or a key map file.
